(19) United States
(12) Patent Application Publication
(10) Pub. No.: US 2010/0000506 A1
(43) Pub. Date: Jan. 7, 2010

(54) Circular saw blade

(75) Inventors: Viktor Heinrichs, Untermeitingen (DE); Johannes Stempfhuber, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/459,613

(22) Filed: Jul. 2, 2009

(30) Foreign Application Priority Data
Jul. 3, 2008 (DE) 10 2008 040 104.8

(51) Int. Cl. B28D 1/04

(52) U.S. Cl. 125/15; 83/663

(57) ABSTRACT

A circular saw blade has a guide plate (11), a plurality of pendulum-like cutter carriers provided at a circumferential outer region (12) of the guide plate (11), and cutters (21, 22) provided at radially outer ends (17) of the cutter carriers (14), respectively, the cutter carriers (14) being secured at their radially inner ends remote from the cutters (21, 22) to the guide plate (11) with a plurality of fastening elements (15) for pivotal movement in a plane defined by the guide plate (11).

### BACKGROUND OF THE INVENTION

1. Field of the Invention

The present invention relates to a circular saw blade having a guide plate and cutter carriers arranged at the circumferential outer region of the guide plate and provided with cutters.

2. Description of the Prior Art

German Publication DE 20 31 846 A1 discloses a circular saw blade with cutting teeth fixedly secured at the outer circumference of the saw blade. The cutting teeth are so formed that the circular saw blade can rotate in opposite directions. The drawback of the saw blade disclosed in DE 20 31 846 A1 consists in that when one or several cutting teeth are damaged or break-off, the entire saw blade need be replaced.

German Publication DE 32 40 100 A1 discloses a circular saw blade in which a plurality of cutter strips or cutter carriers, which are provided with teeth, are arranged on a guide plate. The cutter strips are fixedly secured on the guide plate by soldering or welding.

The drawback of the saw blade disclosed in DE 32 40 100 A1 consists in that the entire saw blade must be replaced in case of wear or breakage of a single cutting element. Another drawback of this saw blade consists in that it can be driven only in one direction.

Accordingly, an object of the present invention is to provide a circular saw blade in which the above-discussed drawbacks of prior art saw blades are eliminated.

Another object of the present invention is to provide a circular saw blade having an increased service life.

### SUMMARY OF THE INVENTION

These and other objects of the present invention, which will become apparent hereinafter, are achieved by providing a circular saw blade with pendulum-like cutter carriers which are secured, at their radially inner ends remote from the cutters, to the guide plate with respective fastening elements for pivotal movement in a plane defined by the guide plate.

The present invention makes it possible, in case of wear or breakage of a single cutter, to replace only the cutter carrier with the damaged cutter or cutters in order to again put the saw blade in a good working order. To this end, only the fastening element, which secures a respective cutter carrier to the guide plate, e.g., a screw, need be loosened up in order to detach the cutter carrier from the guide plate. Because only separate cutter carriers with defective cutters can be replaced, the service life of the inventive saw blade can be noticeably increased. Simultaneously, because of pivotability of the pendulum-like cutter carriers, the inventive circular saw blade can be used in both possible rotational direction (clockwise and counterclockwise).

Advantageously, stops are provided in the circumferential outer region of the guide plate for limiting the pivotal movement o the pendulum-like cutter carriers. This insures that with a stationary saw blade, the cutters do not move, whereby damage of sensitive hard metal elements is prevented.

Advantageously, the pendulum-like cutting carriers each has a maximum pivot angle of ±10°, preferably ±5°. This pivot angle insures that the cutter, which are oriented in a direction opposite the rotational direction of the saw blade never contact a to-be-cut workpiece, which prevents break-off of these cutters.

It is advantageous when at a radially outer end of each pendulum-like cutter carrier, at its opposite corners, there are provided, respectively, at least one first cutter and at least one second cutter. This insures the same cut quality in both rotational direction of the inventive circular saw blade.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a side view of a circular saw blade according to the present invention; and

FIG. 2 a side view of a detail of the saw blade shown in FIG. 1 at an increased, in comparison with FIG. 1, scale.

### DETAILED DESCRIPTION OF THE PREFERRED EMBODIMENT

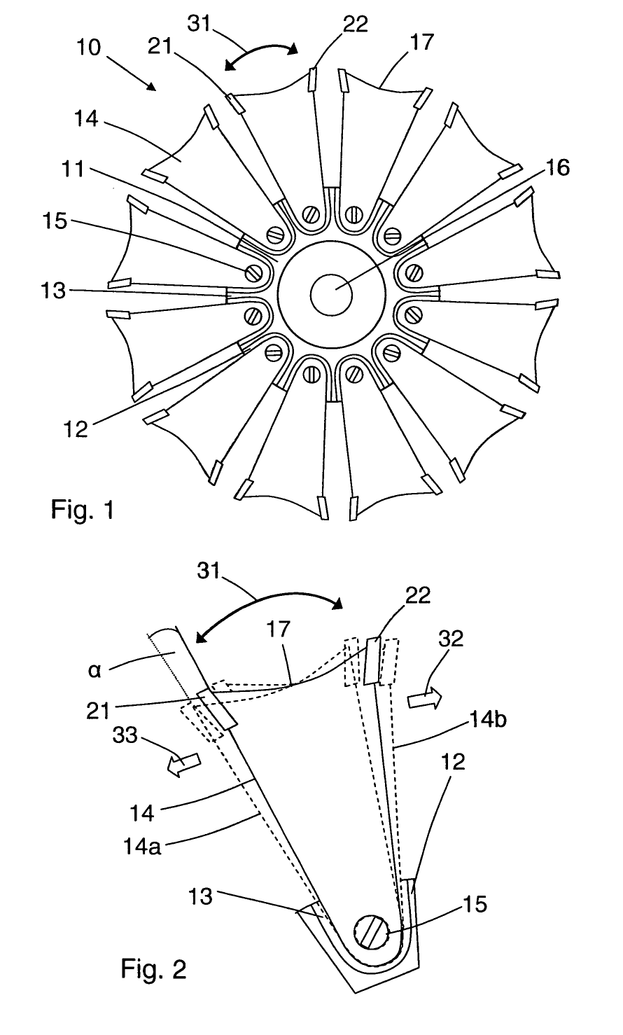

A saw blade 10 according to the present invention, which is formed as a circular saw blade and is shown in FIGS. 1-2, has a guide plate 11 located radially inwardly with respect to an outer circumference of the saw blade 10, and a plurality of pendulum-like cutter carriers 14 provided at the circumferential outer region 12 of the guide plate 11. The pendulum-like cutter carriers 14 pivot in a plane defined by the guide plate 11 in opposite directions, as shown with a double arrow 31 in FIGS. 1-2. The guide plate 11 can, e.g., also be formed as a flange. In the embodiment shown in the drawings, exactly twelve cutter carriers 14 are arranged on the guide plate 11. The cutter carriers 14 are releasably secured on the guide plate 11 with fastening elements 15 which can be formed, e.g. as screws. Alternatively, the fastening elements can be formed as pins, with the cutter carriers 14 being axially fixedly secured on the pins with a common holding member such as, e.g., plate or cover.

In the circumferential outer region 12 of the guide plate 11, there are provided stops 13 which are formed as radially extending ribs and which limit the pivotal movements of the cutter carriers 14. The cutter carriers 14 pivot in each of the opposite direction by a maximal pivot angle α of ±10°, preferably, ±5° (see FIG. 2).

At the radially outer ends 17 of the cutter carriers 14, there are provided, at opposite corners of each cutter carrier 14, a first cutter 21 and a second cutter 22. Thereby, the saw blade 10 can be driven in both possible rotational directions.

Upon rotation of the circular saw blade 10 in a clockwise direction (arrow 32 in FIG. 2), the cutter carriers 14 tilt in an opposite direction, as shown with dash lines of the cutter carrier 14a in FIG. 2.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A circular saw blade, comprising a guide plate (11); a plurality of pendulum-like cutter carriers (14) provided in a circumferential outer region (12) of the guide plate (11); cutters (21, 22) provided at radially outer ends (17) of the cutter carriers (14), respectively, the cutter carriers (14) being secured at radially inner ends thereof remote from the cutters (21, 22) to the guide plate (11) for pivotal movement in a plane defined by the guide plate (11); and a plurality of fastening elements (15) for pivotally securing the cutter carriers (14) to the guide plate (11).

2. A saw-blade according to claim 1, further comprising stops (13) provided in the circumferential outer region (12) of the guide plate (11) for limiting the pivotal movement of the pendulum-like cutter carriers (14).

3. A saw blade according to claim 1, wherein the pendulum-like cutter carriers (14) each has a maximum pivot angle (α) of ±10°.

4. A saw blade according to claim 1, wherein at a radially outer end (17) of each pendulum-like cutter carrier (14), at opposite corners thereof, there are provided, respectively, at least one first cutter (21) and at least one second cutter (22).
